(19) United States
(12) Patent Application Publication
(10) Pub. No.: US 2006/0227539 A1
(43) Pub. Date: Oct. 12, 2006

(54) Switch device for a luminous decoration

(76) Inventor: Sen-Fang Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/334,447

(22) Filed: Jan. 19, 2006

(30) Foreign Application Priority Data
Mar. 21, 2005 (TW) 094204314

(51) Int. Cl. F21L 4/00

(52) U.S. Cl. 362/157

(57) ABSTRACT

A switch device for a luminous decoration includes a decoration accommodating box and a connecting block. The accommodating box has its bottom bored with a fitting hole formed with a female threaded portion. The connecting block has its upper end formed with a male threaded portion to be threadably combined with the female threaded portion of the accommodating box and has its lower portion formed with a retaining ring for connecting an article thereon. The accommodating box is installed inside with a luminous unit having a switch holder to be pressed by the connecting block. The luminous unit can be controlled to turn on and off light by adjusting the contact condition of the connecting block and the switch holder of the luminous unit.

### BACKGROUND OF THE INVENTION

1. Field of the Invention

This invention relates to a switch device for a luminous decoration, particularly to one able to control a luminous unit to shine and assemble an article thereon.

2. Description of the Prior Art

A conventional lipstick set is monotonous in structure, but today people have higher and higher requirement for quality of living and of articles they use. Therefore, for elevating product competitive force, products must be original and special and should be renovated in their external looks in addition to substantial functions.

### SUMMARY OF THE INVENTION

The objective of the invention is to offer a switch device for a luminous decoration, including a decoration accommodating box and a connecting block. The accommodating box has its bottom bored with a fitting hole formed with a female threaded portion. The connecting block has its upper end formed with a male threaded portion to be threadably combined with the female threaded portion of the accommodating box. The connecting block has its lower portion formed with a retaining ring for connecting with a decorative article. The accommodating box has its interior installed with a luminous unit having a switch holder to be pressed by the upper end of the connecting block. The switch holder of the luminous unit is disposed with a battery unit connected with a luminous body, which can be controlled by the connecting block to turn on and off light.

### BRIEF DESCRIPTION OF DRAWINGS

This invention will be better understood by referring to the accompanying drawings, wherein:

FIG. 1 is a cross-sectional view of a first preferred embodiment of a switch device for a luminous decoration in the present invention;

FIG. 2 is a cross-sectional view of the first preferred embodiment of the switch device for a luminous decoration in a using condition in the present invention;

FIG. 3 is another cross-sectional view of the first preferred embodiment of the switch device for a luminous decoration in another suing condition in the present invention;

FIG. 4 is a third cross-sectional view of the first preferred embodiment of the switch device for a luminous decoration in another using condition in the present invention;

FIG. 5 is a cross-sectional view of a second preferred embodiment of a switch device for a luminous decoration in the present invention; and

FIG. 6 is a cross-sectional view of the second preferred embodiment of the switch device for a luminous decoration in a using condition in the present invention.

### DETAILED DESCRIPTION OF THE PREFERRED EMBODIMENT

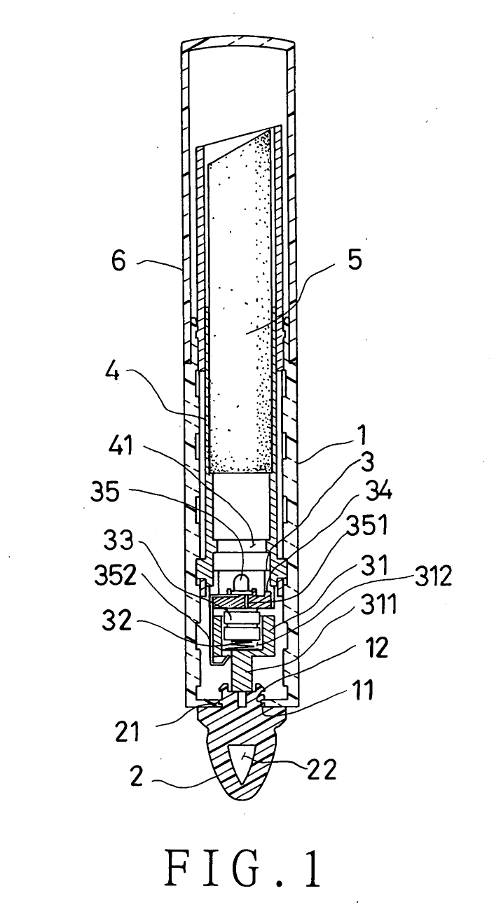

A first preferred embodiment of a switch device for a luminous decoration in the present invention, as shown in FIG. 1, includes an accommodating box 1, a connecting block 2, a luminous unit 3, a receiving sleeve 4 and a protective cover 6 combined together.

The accommodating box 1 has its bottom bored with a fitting hole 11 formed with a female threaded portion 12 and its interior installed with the luminous unit 3.

The connecting block 2 to be combined with the accommodating box 1 has its upper end formed with a male threaded portion 21 to be threadably combined with the female threaded portion 12 of the accommodating box 1 and its lower portion formed with a retaining ring 22 for connecting with an article, such as a necklace, a key ring or the like.

The luminous unit 3 positioned in the accommodating box 1 is provided with a switch holder 31 having a press post extending downward from its underside to be pressed by the upper end of the connecting block 2. The switch holder 31 has its upper portion formed with an accommodating chamber 312 orderly fitted therein with an elastic member 32 and a battery unit 33 contacting with the upper end of the elastic member 32. Further, the switch unit 31 is movably mounted thereon with a fixing base 34 bored with an insert hole in the center for one adapter 351 of a luminous body 35 to pass therethrough and then contact with the upper end of the battery unit 33. The luminous body 35 has the other adapter 352 extending downward and then bent inward to be positioned under the lower end of the elastic member 32, thus making up a circuit. The fixing base 34 is fixed under the fitting hole 41 of the receiving sleeve 4 movably assembled with the accommodating box 1, and a lipstick 5 is fitted with the upper end of the fitting hole 41 of the receiving sleeve 4.

The protective cover 6 is movably mounted on the upper end of the accommodating box 1 for protecting the lipstick 5 and keeping it clean.

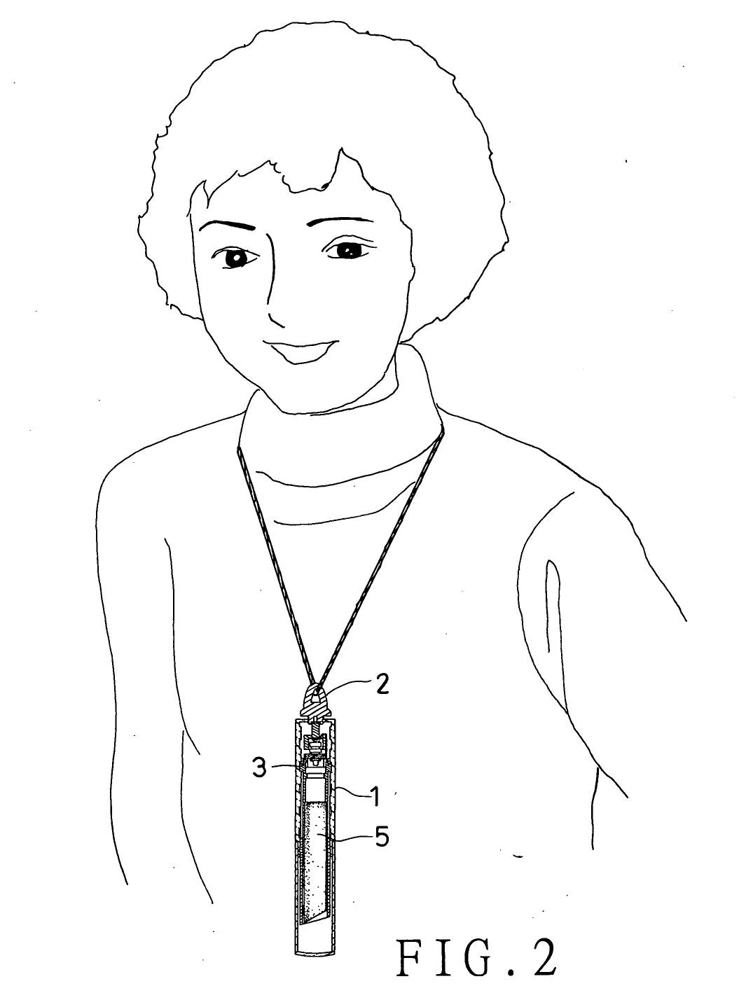

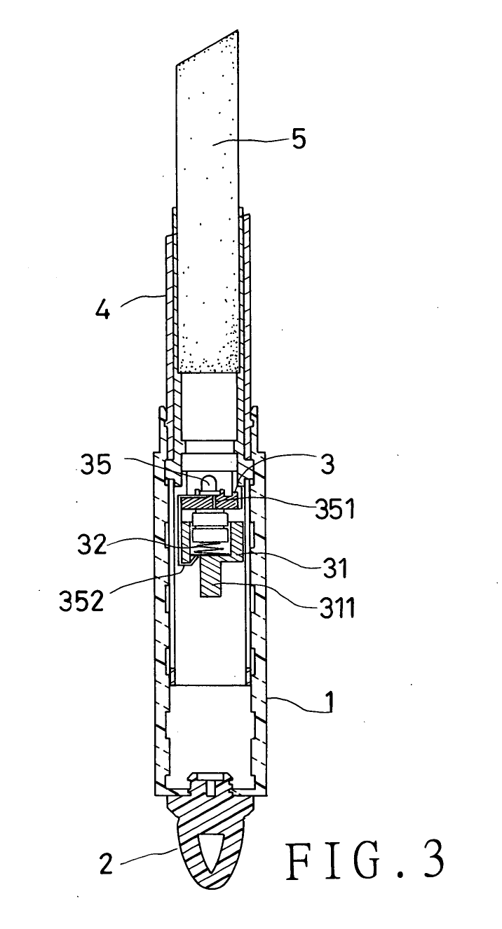

By so designing, a necklace can be connected with the retaining ring 22 of the connecting block 2. In using, as shown in FIGS. 1, 2 and 3, firstly, the protective cover 6 is removed from the accommodating box 1 to let the lipstick 5 exposed outward to be ready for making up, and then the receiving sleeve 4 movably combined with the accommodating box 1 is actuated to move upward from the accommodating box 1. At this time, the luminous unit 3 fixed at the lower side of the receiving sleeve 4 is synchronously actuated to move upward to let the press post 311 of the switch holder 31 gradually disconnected from the upper end of the connecting block 2 and moved upward together with the receiving sleeve 4. Accordingly, the luminous unit 3 and the connecting block 2 is separated from each other for quite a distance to let the elastic member 32 freed from the compression of the switch holder 31 and the connecting block 2, so the elastic member 32 recovers its original position to push the switch holder 31 to move downward. Simultaneously, the adapter 352 of the luminous body 35 will contact with the underside of the elastic member 32 and make electrical connection with the battery unit 33 to enable the luminous body 35 to give out light, which will pass through the lipstick 5 and produce an especially brilliant visual effect.

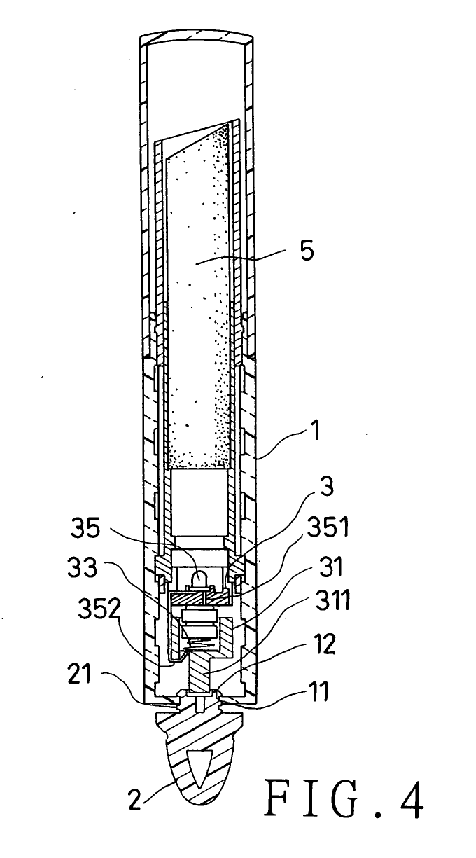

Referring to FIG. 4, when the luminous body 35 is expected to keep shining under the condition of the lipstick 5 not used, simply unscrew the male threaded portion 21 of the connecting block 2 and gradually move it outward to form a space between the press post 311 of the switch holder 31 and the upper end of the connecting block 2, Then the elastic member 32 can push the switch holder 31 to move downward and contact with the adapter 352 of the luminous body 35 to let the luminous body 35 electrically connected for emitting light. To turn out the luminous body 35, only make the connecting block 2 threadably moved upward to its original position to let its upper end press against the press post 311 of the switch holder 31. At this time, the elastic member 32 in the switch holder 31 is compressed and disconnected from the adapter 352 of the luminous body 35 to cut off the circuit.

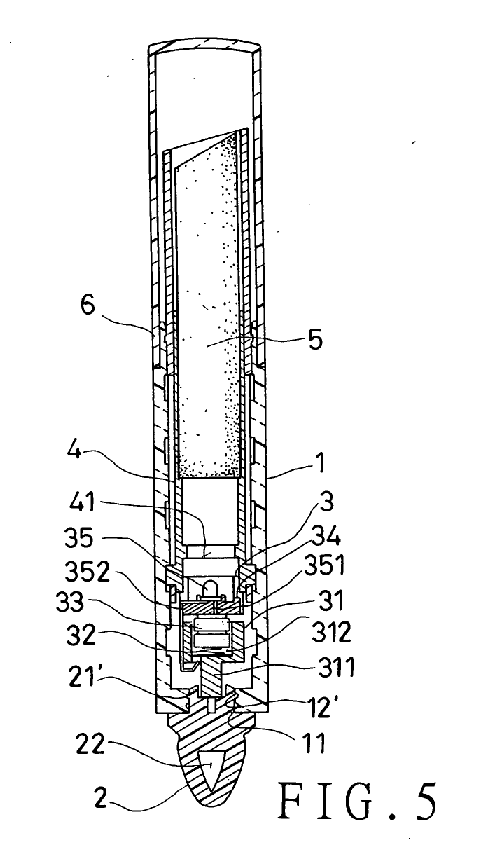

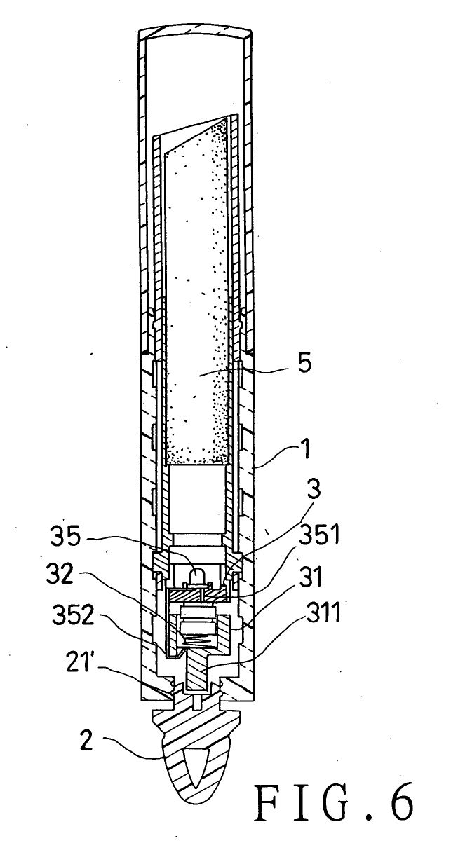

A second preferred embodiment of a switch device for a luminous decoration, as shown in FIGS. 5 and 6 is to have the interior of the fitting hole 11 at the lower end of the accommodating box 1 formed with a plurality of concave rings 12′ and have the upper portion of the connecting block 2 formed with a plurality of convex ring 21′ to be threadably combined with the concave rings 12′ of the accommodating box 1, letting the upper end of the connecting block 2 press against the press post 311 of the switch holder 31 and making the luminous unit 3 electrically disconnected. To let the luminous body 35 give out light, only threadably move the connecting block 2 outward to have its convex rings 21′ engaged with the concave rings 12′ at the lower end of the fitting hole 11 of the accommodating box 1. At this time, the upper end of the connecting block 2 is separated form the press post 311 of the switch holder 31 for quite a distance, enabling the elastic member 32 in the switch holder 31 to press against the adapter 352 of the luminous body 35 and make the luminous body 35 electrically connected for giving out light.

As can be understood from the above description, this invention has the following advantages.

1. The accommodating box is installed with the luminous unit in the interior, having its lower end threadably combined with the connecting block having its upper end pressing the switch holder of the luminous unit. In addition, the connecting block has its lower portion formed with the retaining ring for connecting with a necklace, a key ring or the like. The luminous unit can be controlled to give out light and produce brilliant visual effect of the decoration by adjusting the contact condition between the connecting block and the switch holder.

2. Apart from serving as a decoration, the accommodating box can be fitted therein with a lipstick to be used for making up at any time.

While the preferred embodiments of the invention have been described above, it will be recognized and understood that various modifications may be made therein and the appended claims are intended to cover all such modifications that may fall within the spirit and scope of the invention.

What is claimed is:

1. A switch device for a luminous decoration comprising a decoration accommodating box and a connecting block, said accommodating box having its bottom bored with a fitting hole, said fitting hole formed with a female threaded portion, said connecting block having its upper end formed with a male threaded portion to be threadably combined with said female threaded portion of said accommodating box, said accommodating box installed therein with a luminous unit, said luminous unit provided with a switch holder to be pressed by the upper end of said connecting block, said switch holder assembled with a battery unit connected with a luminous body, said luminous unit electrically disconnected when said connecting block is moved upward to press against said switch holder, said luminous unit electrically connected when said connecting block is moved downward and separated from said switch holder, said luminous body controlled by said connecting block to turn on and off light.

2. The switch device for a luminous decoration as claimed in claim 1, wherein said connecting block has its lower portion formed with a retaining ring for combining with an article.

3. A switch device for a luminous decoration comprising a decoration accommodating box and a connecting block, said accommodating box having its bottom bored with a fitting hole, said fitting hole formed with a plurality of concave rings, said connecting block having its upper portion formed with a plurality of convex rings to be combined with said concave rings of said accommodating box, said accommodating box having its interior installed with a luminous unit, said luminous unit provided with a switch holder to be pressed by the upper end of said connecting block, said switch holder of said luminous unit disposed with a battery unit connected with a luminous body, said luminous unit electrically disconnected when said connecting block is moved upward to press against said switch holder, said luminous unit electrically connected when said connecting block is moved downward and separated from said switch holder, said luminous body controlled by said connecting block to turn on and off light.

4. The switch device for a luminous decoration as claimed in claim 3, wherein said connecting block has its lower half portion formed with a retaining ring for connecting with an article.
